(19) United States
(12) Patent Application Publication
(10) Pub. No.: US 2011/0112821 A1
(43) Pub. Date: May 12, 2011

(54) METHOD AND APPARATUS FOR MULTIMODAL CONTENT TRANSLATION

(76) Inventors: ANDREA BASSO, Marlboro, NJ (US); David Gibbon, Lincroft, NJ (US); Zhu Liu, Marlboro, NJ (US); Bernard S. Renger, New Providence, NJ (US); Behzad Shahraray, Holmdel, NJ (US)

(21) Appl. No.: 12/616,550

(22) Filed: Nov. 11, 2009

(51) Int. Cl. G06F 17/28

(52) U.S. Cl. 704/2

(57) ABSTRACT

In one embodiment, the present disclosure is a method and apparatus for multimodal content translation. In one embodiment, a method for translating content includes receiving the content via a first modality, extracting at least one verbal component and at least one non-verbal component from the content, and translating the at least one verbal component and the at least one non-verbal component into translated content, where the translated content is in a form for output in a second modality.

### FIELD OF THE DISCLOSURE

The present disclosure relates generally to methods for translating content between different modalities. One embodiment of the present disclosure is implemented within the context of social networks.

Users communicate with each other over communication devices in a variety of formats. For example, users may send messages directly to other users as a one-to-one interaction. Alternatively, within the social network context, users may post publicly or privately viewable messages (e.g., text-based, video-based, audio-based, or tactile-based messages) on their own accounts or to each other's accounts. Thus, a plurality of modalities is supported in these communications. A “modality” is a sense through which a human can receive the output of a computing device or provide input to the computing device. Any human sense can be translated into a modality.

Modern communication applications can convey the verbal and non-verbal content of a message (e.g., the words contained in the message and associated emotions). Non-verbal content plays a key role in human communications and can entirely change the meaning of a particular instance of verbal content (for instance, the phrase “Hey you!” could be uttered in a friendly way, a surprised way, an angry way, or the like).

### SUMMARY

In one embodiment, the present disclosure is a method and apparatus for multimodal content translation. In one embodiment, a method for translating content includes receiving the content via a first modality, extracting at least one verbal component and at least one non-verbal component from the content, and translating the at least one verbal component and the at least one non-verbal component into translated content, where the translated content is in a form for output in a second modality.

### BRIEF DESCRIPTION OF THE DRAWINGS

The teaching of the present disclosure can be readily understood by considering the following detailed description in conjunction with the accompanying drawings, in which:

FIG. 1 is a schematic diagram illustrating an exemplary network, according to embodiments of the present disclosure;

FIG. 2 is a flow diagram illustrating a first embodiment of a method for performing multimodal content translation, according to the present disclosure;

FIG. 3 is a flow diagram illustrating a second embodiment of a method for performing multimodal content translation, according to the present disclosure; and

FIG. 4 is a high level block diagram of the multimodal content translation method that is implemented using a general purpose computing device.

To facilitate understanding, identical reference numerals have been used, where possible, to designate identical elements that are common to the figures.

### DETAILED DESCRIPTION

In one embodiment, the present disclosure is a method and apparatus for multimodal content translation. By “multimodal,” it is meant that embodiments of the present disclosure can translate content between different modalities (such as visual, audible, and tactile modalities) while preserving both the verbal and non-verbal components of the content. For example, a textual translation of an audio message may include a transcription of the verbal content (i.e., words) as well as non-verbal indicators (e.g., punctuation) that are intended to convey the emotion expressed in the audio message. In further embodiments, the present disclosure generates synthetic feedback based on reactions to events. In one embodiment, the translation is performed in real time. One embodiment of the present disclosure is implemented within the context of social networks.

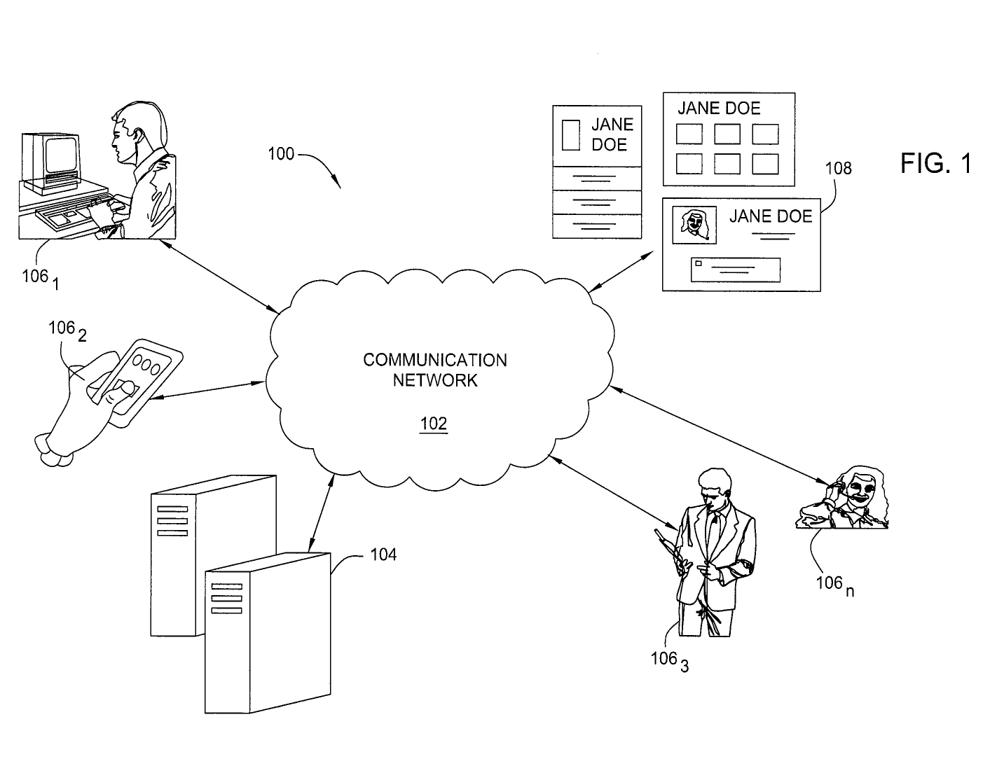

FIG. 1 is a schematic diagram illustrating an exemplary network 100, according to embodiments of the present disclosure. As illustrated, the network 100 comprises a communication network 102, a broker 104 connected to the communication network 102, and a plurality of user devices 106₁-106ₙ (hereinafter collectively referred to as “user devices 106”) connected to the communication network 102. In one embodiment, the network 100 optionally comprises at least one social networking application 108 connected to the communication network 102. The social networking application 108 can be hosted on one or more application servers.

The communication network 102 is any kind of network that facilitates communications between remote users and between users and remote applications. For example, the communication network 102 may include one or more of: a computer network (e.g., a local area network, a wide area network, a virtual private network), the Internet, a packet network, an internet Protocol (IP) network, a public switched telephone network, a peer-to-peer network, a wireless network, a cellular network, or the like.

The users connect to the communication network 102 via one or more user devices (broadly communication devices) 106. These user devices may include, for example: landline telephones, cellular telephones, personal digital assistants, personal computers, laptop computers, personal media players, gaming consoles, set top boxes, or the like. Using these communication devices 106, the users are able to connect to each other and to the social networking application 108 via the communication network 102.

In one embodiment, the social networking application 108 comprises a web portal that hosts content provided by the users. In one embodiment, the web portal is implemented in one or more devices such as servers, databases, or the like. The social networking application 108 may comprise one or more of: a blogging, micro-blogging, or podcasting application (e.g., the Twitter® social networking service), a photo or video sharing application (e.g., the Flickr® social networking service), or a multimedia social networking application (e.g., the Facebook® social networking service). In one embodiment, the social networking application 108 is accessed over the communication network 102 via one or more uniform resource locators (URLs).

The user devices 106 access the social networking application 108 via the communication network 102. Using the social networking application 108, the users are able to exchange messages with each other. The users may also exchange messages directly with each other (i.e., without using the social networking application 108 as an intermediary).

In one embodiment, the broker 104 receives and transmits content from and to the user devices 106 and the social networking application 108. Thus, the user devices 106 and the social networking application 108 serve as sources of content for the broker 104. When needed or requested, the broker 104 translates this content into appropriate modalities. For example, a user may use a user device 106ₙ, e.g., a cellular phone, to record an audio message. The broker 104 may then translate this audio message into text for posting to the user's account on the social networking application 108, which may be, for example, a text-based micro-blogging application. Alternatively, the broker may transmit the text form of the audio message directly to another user, who views the text, for example, on his desktop computer 106₁.

Additionally, the broker 104 may filter its output in accordance with preferences provided by the users regarding their communications within the network 100. For instance, a user may request that she receives or not receives content whose non-verbal components meet certain criteria (e.g., only “happy” content, no “angry” content, etc.). Alternatively, a user may request that content that she provides of a certain type only be shared with certain other users who are specifically identified (e.g., only share “angry” content with “user X”). In one embodiment, these other users are identified by individual or by membership in an identified group (e.g., “user X” or “Family”). In one embodiment, these preferences are extracted from the social networking application 108.

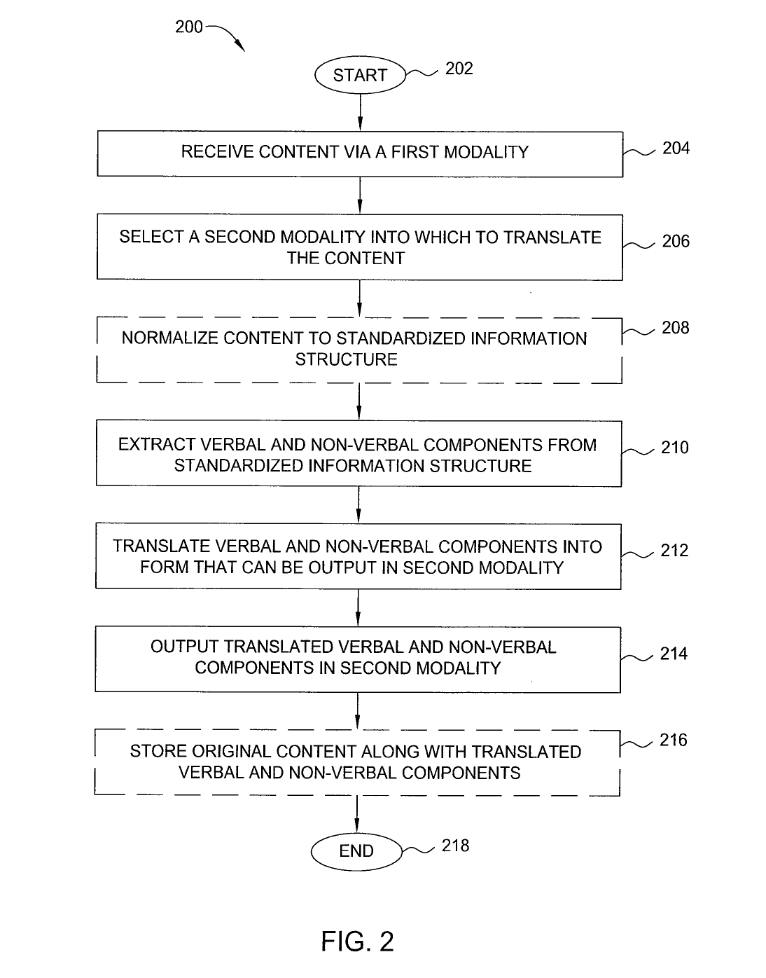

FIG. 2 is a flow diagram illustrating a first embodiment of a method 200 for performing multimodal content translation, according to the present disclosure. The method 200 may be implemented, for example, by the broker 104 illustrated in FIG. 1. It will be appreciated, however, that the method 200 is not limited to use with the network 100 as illustrated in FIG. 1 and may have application in networks having configurations that differ from the network 100.

The method 200 is initialized in step 202 and proceeds to step 204, where the broker 104 receives content via a first modality. In one embodiment, the first modality comprises one of: a visual modality (e.g., where the content is a video, an image, or text), an audible modality (e.g., where the content is an audio file), and a tactile modality (e.g., where the content is a gesture made via a tactile sensing device (e.g., a tactile controller or a tactile sensor such as a pressure sensor, a motion sensor, a temperature sensor, a mouse, and the like) that can sense the gesture). In one embodiment, the content is received directly from a user device 106. In another embodiment, the content is retrieved from the social networking application 108. As an example, the content may be an audio message recorded on a user's cellular phone in which the user shouts “Hey you!” in an angry voice. In a further embodiment, an indication of a medium or device to which the translated content is to be output accompanies the content. Thus, continuing the example above, the audio message may include an indication that the translated audio message should be output to the user's text-based micro-blogging account.

In step 206, the broker 104 selects a second modality into which to translate the content. In one embodiment, the second modality comprises one of: a visual modality, an audible modality, and a tactile modality. In one embodiment, the second modality is a different modality than the first modality. In another embodiment, the second modality is the same as the first modality.

In one embodiment, the selection of the second modality is made under the direction of the user who provided the content (e.g., where the user transmits a signal to the broker 104 indicating the selection of the second modality). In another embodiment, the selection of the second modality is made based on the capabilities of a medium or device to which the broker 104 expects to output the translated content. For instance, continuing the example above, the signal may indicate that the user wishes to have the audio message translated into a text-based message. Alternatively, the broker 104 may determine that the micro-blogging account to which the audio message is to be output can only display text-based content.

In optional step 208 (illustrated in phantom), the broker 104 normalizes the content into a standardized information structure. Step 208 is optional because in some embodiments, the normalization is performed by the device that provides the content to the broker 104. This standardized information structure includes data structures that capture both the verbal and non-verbal components of the content. For instance, the data structures may include data structures that transcribe the verbal components, as well as descriptors that describe the non-verbal components. The broker 104 then extracts verbal and non-verbal components from the standardized information structure in step 210. For instance, continuing the example above, the verbal components of the audio message may include the words “Hey you,” while the non-verbal components include the user's angry tone of voice or the volume of the user's voice. Other non-verbal components, depending on the modality of the content, may include: punctuation, capitalization, grammatical characteristics, facial expressions, gestures, or the force with which the user interacts with an input tactile device (e.g., typing on a keyboard or shaking a controller or telephone handset).

In step 212, the broker 104 translates the verbal and non-verbal components of the content into a form that can be output in the second modality. This translation involves translating both the verbal components (i.e., words) and the non-verbal components (e.g., emotions) of the content. In one embodiment, the verbal components are translated in accordance with an automatic speech recognition (ASR) program, an optical character recognition (OCR) program, or a text-to-speech (TTS) program. In one embodiment, the non-verbal components can be derived using sensors that monitor inflections in the user's voice (e.g., shouting), expressions on the user's face (e.g., smiling), gestures made by the user (e.g., waving), tactile inputs from the user (e.g., speed or impact with which the user types on a keyboard). Non-verbal components can also be derived from the grammatical characteristics of the content (e.g., missing punctuation or use of all capital letters). In a further embodiment, translation in accordance with step 212 may be modified in accordance with instructions included with the content. For example, the user providing the content may want to exclude certain verbal or non-verbal components from the translation (e.g., don't translate the fact that an audio message is shouted). Alternatively, the user may wish to synthesize certain verbal or non-verbal content (e.g., even though the audio message was not shouted, to translate the audio message as if it were shouted).

The resultant translated content may include one or more of: an audio file, a video file, an image file, a text file, or a command signal that causes a device to generate a tactile signal (e.g., such as a signal that causes a gaming controller or a cellular phone to vibrate, to heat up, to flash visibly and so on). For instance, continuing the example above, the broker 104 may transcribe the verbal components of the audio message as the words “Hey you.” The broker 104 may further add an exclamation point to the transcription (making the transcription read “Hey you!”) and/or capitalize the entire transcription (making the transcription read “HEY YOU!”) in order to convey the non-verbal components of the audio message (e.g., the angry tone of voice). Alternatively, if the audio message were to be translated into an image-based message, the image-based message might comprise an audio replay of the audio message dubbed over an image or emoticon of an angry face. Additionally, the translation may include a tactile signal, such as a signal that causes the recipient's cellular phone to vibrate with a particular intensity. In the case where the first modality and the second modality are the same, the translation may simply convey additional information that was not present in the original content. For example, the text-based content “Hey you” can be translated into the text-based translation “Hey you [very angry],” which conveys additional information regarding the non-verbal component of the original content (i.e., the “very angry” emotion).

In step 214, the broker 104 outputs the verbal and non-verbal components of the translated content in the second modality. In one embodiment, the translated content is output to one or more of: a blogging, micro-blogging, or podcasting application (e.g., the Twitter® social networking service), a photo or video sharing application (e.g., the Flickr® social networking service), or a multimedia social networking application (e.g., the Facebook® social networking service). Alternatively, the translated content may be output directly to another user device 106ₙ (e.g., to another user's cellular phone).

In optional step 216 (illustrated in phantom), the broker 104 stores the original content, along with the translated verbal and non-verbal components. In one embodiment, this data is stored locally at the broker 104. In another embodiment, this data is stored in a remote database. In this way, the content and the translated components of the content are available for review at a later time. In one embodiment, the stored data is stored for only a defined amount of time (e.g., x days or until the occurrence of event Y).

The method 200 then terminates in step 218.

The present disclosure therefore allows users to translate content for output into different modalities, while retaining the non-verbal components of the content in the translation. In this manner, the full meaning and intent of the original content is conveyed despite the change in modality. The present disclosure may also be useful in cases where two users speak different languages. In such an instance, the ability to convey the non-verbal components of the content may enhance the users' understanding of each other.

In one embodiment, the translated content is available on the output medium or device for only a defined period of time. For instance, the user may specify that the translated content expire after a certain date or event. As an example, the translated content might include an invitation for a party, where the invitation expires once the party has taken place. In another embodiment, the translated content is updated periodically based on feedback from the user. For instance, the user's mood may change with time. In one embodiment, a device used by the user to provide content continuously monitors and broadcasts to the broker 104, to another user device 106, or to the social networking application 108 the user's mood.

Embodiments of the present disclosure may also be used to assess a user's feedback with respect to content that is being presented to her. For example, if the user is using her telephone to cast a vote for a candidate on a television talent show, the present disclosure may be used to record not only the user's vote (e.g., yes or no, Candidate A or Candidate B, etc.), but also to record the emphasis that the user places on the vote (e.g., her tone of voice, how hard she presses on the telephone keys, how hard she shakes the telephone handset etc.). This non-verbal feedback may be recorded via biometric or other types of sensors embedded in the device via which the user provides the feedback (e.g., the telephone). In further embodiments, the feedback may be recorded for a group of users (e.g., where the group comprises at least two users).

Feedback of this type may also be useful for gauging audience feedback during live broadcast programs (e.g., broadcast over the television, the radio, the Internet, or the like). For instance, the present disclosure may be used to gauge audience reaction to a speech or a political debate (e.g., is the audience interested or uninterested in a particular issue; does the audience like or dislike a particular candidate?). This audience reaction data, provided in real-time, e.g., during the airing of a live program, can help to tailor the content of the program (e.g., by signaling that a debate should move on to a new issue).

Feedback of this type may also be useful in educational environments, wherein a teacher may wish to gauge the students' comprehension of a subject or their attention spans. This may allow the teacher to gauge this information honestly without singling out a student.

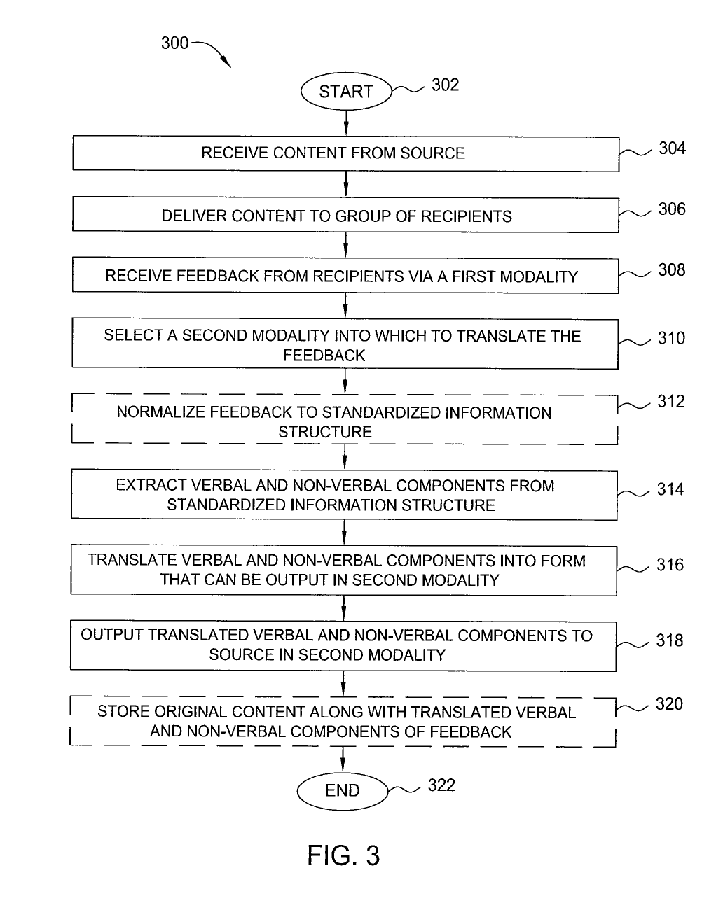

FIG. 3 is a flow diagram illustrating a second embodiment of a method 300 for performing multimodal content translation, according to the present disclosure. In particular, the method 300 provides a mechanism of transmitting feedback relating to content to a source of the content, thereby helping the source to better tailor the content to the audience. The method 300 may be implemented, for example, by the broker 104 illustrated in FIG. 1. It will be appreciated, however, that the method 300 is not limited to use with the network 100 as illustrated in FIG. 1 and may have application in networks having configurations that differ from the network 100.

The method 300 is initialized in step 302 and proceeds to step 304, where the broker 104 receives content from a source. For example, the source may be a broadcaster of a political debate, where the content is the debate broadcast. In step 306, the broker 104 delivers the content to a group of recipients. For instance, continuing the example above, the recipients may comprise a group of people watching the debate on television.

In step 308, the broker 104 receives feedback from the recipients via a first modality. In one embodiment, the first modality comprises one of: a visual modality (e.g., where the content is a video, an image, or text), an audible modality (e.g., where the content is an audio file), and a tactile modality (e.g., where the content is a gesture made via a controller or a biometric response recorded by a sensor). In one embodiment, the feedback comprises feedback provided directly by the recipient (e.g., a short messaging service (SMS) message sent by the recipient). In another embodiment, the feedback comprises feedback provided indirectly by the recipient (e.g., readings from sensors that monitor the recipient's emotions and/or biometric responses). For instance, continuing the example above, the feedback may be an SMS message sent using the user's cellular phone in which the user writes “This guy is wrong.” Alternatively, the feedback may be a sensor reading indicating that the user struck the keys with x amount of force when typing the SMS message, potentially indicating anger.

In step 310, the broker 104 selects a second modality into which to translate the feedback. In one embodiment, the second modality comprises one of: a visual modality, an audible modality, and a tactile modality. In one embodiment, the second modality is a different modality than the first modality. In one embodiment, the selection of the second modality is made under the direction of the provider of the content (e.g., where the provider transmits a signal to the broker 104 indicating selection of the second modality). In another embodiment, the selection of the second modality is made based on the capabilities of a medium or device to which the broker 104 expects to output the translated feedback. For instance, continuing the example above, the signal may indicate that the provider wishes to have the feedback translated into a text-based message or into a signal to a visual indicator (e.g., a set of color-coded light emitting diodes (LEDs)). Alternatively, the broker 104 may determine that the medium or device to which the feedback is to be output can only display text-based content.

In optional step 312 (illustrated in phantom), the broker 104 normalizes the feedback into a standardized information structure. Step 312 is optional because in some embodiments, the normalization is performed by the devices that provide the feedback to the broker 104. This standardized information structure includes data structures that capture both the verbal and non-verbal components of the feedback. For instance, the data structures may include data structures that transcribe the verbal components, as well as descriptors that describe the non-verbal components. The broker 104 then extracts verbal and non-verbal components from the standardized information structure in step 310. For instance, continuing the example above, the verbal components of the SMS message may include the words “This guy is wrong,” while the non-verbal components include the force with which the user struck the keys on the cellular phone keypad.

In step 316, the broker 104 translates the verbal and non-verbal components of the feedback into a form that can be output in the second modality. This translation involves translating both the verbal components (i.e., words) and the non-verbal components (e.g., emotions) of the feedback. In one embodiment, the verbal components are translated in accordance with an automatic speech recognition (ASR) program, an optical character recognition (OCR) program, or a text-to-speech (TTS) program. In one embodiment, the non-verbal components can be translated using applications for identifying and translating emotional inputs. Non-verbal components can also be derived from the grammatical characteristics of the feedback (e.g., missing punctuation or use of all capital letters).

The resultant translated feedback may include one or more of: an audio file, a video file, an image file, a text file, or a command signal that causes a device to generate a tactile signal (e.g., such as a signal that causes a gaming controller or a cellular phone to vibrate, to heat up, to flash visibly and so on). For instance, continuing the example above, the broker 104 may translate the SMS message as an angry or negative message and accordingly generate a signal that will cause a corresponding LED in a set of color-coded LEDs to illuminate on a display monitored by the content provider.

In step 318, the broker 104 outputs the verbal and non-verbal components of the translated feedback in the second modality. In one embodiment, the translated feedback is output to one or more of: a blogging, micro-blogging, or podcasting application (e.g., the Twitter® social networking service), a photo or video sharing application (e.g., the Flickr® social networking service), or a multimedia social networking application (e.g., the Facebook® social networking service). Alternatively, the translated feedback may be output directly to the content provider. In a further embodiment, the translated feedback is also output to the recipients who provided the feedback.

In optional step 320 (illustrated in phantom), the broker 104 stores the original feedback, along with the translated verbal and non-verbal components of the feedback. In one embodiment, this data is stored locally at the broker 104. In another embodiment, this data is stored in a remote database. In this way, the feedback and the translated components of the feedback are available for review at a later time. In one embodiment, the stored data is stored for only a defined amount of time (e.g., x days or until the occurrence of event Y).

The method 300 then terminates in step 322.

Although embodiments of the present disclosure are described within the context of social networking applications (e.g., where content for translation is retrieved from a social networking application, or translated content is output to a social networking application), it will be appreciated that embodiments of the disclosure are equally applicable to communication events that do not involve social networking applications. For example, any of the described embodiments of the present disclosure can be implemented in one-to-one communications in which users communicate directly with each other.

Moreover, the content that is translated in accordance with embodiments of the present disclosure may be multimedia content or any other type of content that is not necessarily multimedia content. For example, embodiments of the present disclosure could translate simple text into an image or could translate American Standard Code for Information Interchange (ASCII) text into enhanced text (for example by manipulating font attributes such as size, upper/lower case, color, etc.).

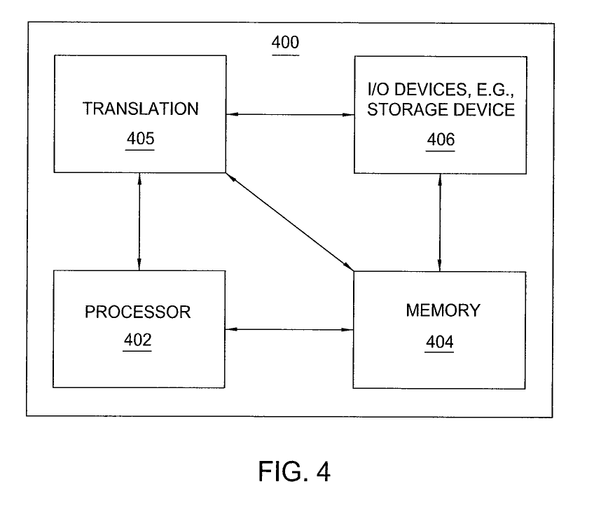

FIG. 4 is a high level block diagram of the multimodal content translation method that is implemented using a general purpose computing device 400. In one embodiment, a general purpose computing device 400 comprises a processor 402, a memory 404, a translation module 405 and various input/output (I/O) devices 406 such as a display, a keyboard, a mouse, a modem, a stylus, a joystick, a keypad, controller, a microphone, a sensor, a camera, and the like. In one embodiment, at least one I/O device is a storage device (e.g., a disk drive, an optical disk drive, a floppy disk drive). It should be understood that the translation module 405 can be implemented as a physical device or subsystem that is coupled to a processor through a communication channel.

Alternatively, the translation module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the translation module 405 for providing multimodal content translation in social networks described herein with reference to the preceding Figures can be stored on a computer readable storage medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for translating content, the method comprising:
receiving the content via a first modality;
extracting at least one verbal component and at least one non-verbal component from the content; and
translating the at least one verbal component and the at least one non-verbal component into translated content, where the translated content is in a form for output in a second modality.

2. The method of claim 1, wherein the second modality is different from the first modality.

3. The method of claim 1, wherein the second modality is a same modality as the first modality.

4. The method of claim 1, further comprising:
outputting the translated content in the second modality.

5. The method of claim 4, further comprising:
filtering the translated content in accordance with at least one preference prior to the outputting.

6. The method of claim 1, wherein a source of the content comprises at least one social networking application.

7. The method of claim 1, wherein a source of the content comprises at least one communication device.

8. The method of claim 1, wherein a source of the content comprises at least one sensor.

9. The method of claim 1, wherein the first modality comprises at least one of: a visual modality, an audible modality, and a tactile modality.

10. The method of claim 1, wherein the second modality comprises at least one of: a visual modality, an audible modality, and a tactile modality.

11. The method of claim 1, wherein the content comprises feedback received in response to presented content that is delivered to a group of recipients.

12. The method of claim 11, wherein the translated content is output to a source of the presented content.

13. The method of claim 11, wherein the translated content is output to the group of recipients.

14. The method of claim 1, further comprising:
continuously monitoring a communication device of a user for the content.

15. The method of claim 1, wherein the at least one non-verbal component comprises at least one of: a punctuation, a capitalization, a grammatical characteristic, a tone of voice, a facial expression, a gesture, and a force with which a source of the content interacts with an input device.

16. The method of claim 1, wherein the second modality is selected by a source of the content.

17. The method of claim 1, wherein the second modality is selected to conform to at least one capability of a device to which the translated content is to be output.

18. The method of claim 1, wherein the translating further comprises:
modifying at least one of the at least one verbal component and the at least one non-verbal component based on an instruction in the content.

19. A computer readable storage medium containing an executable program for translating content, where the program performs steps of:
receiving the content via a first modality;
extracting at least one verbal component and at least one non-verbal component from the content; and
translating the at least one verbal component and the at least one non-verbal component into translated content, where the translated content is in a form for output in a second modality.

20. An apparatus for translating content, comprising:
means for receiving the content via a first modality;
means for extracting at least one verbal component and at least one non-verbal component from the content; and
means for translating the at least one verbal component and the at least one non-verbal component into translated content, where the translated content is in a form for output in a second modality.
